(19) United States
(12) Patent Application Publication
(10) Pub. No.: US 2012/0072819 A1
(43) Pub. Date: Mar. 22, 2012

(54) Asynchronous Redrawing in Online Document Processors

(75) Inventors: Edgard Lindner, New York, NY (US); Olga Belomestnykh, New York, NY (US); Luiz Amaral Franca Pereira Filho, New York, NY (US)

(73) Assignee: GOOGLE, INC., Mountain View, CA (US)

(21) Appl. No.: 13/166,844

(22) Filed: Jun. 23, 2011

Related U.S. Application Data
(60) Provisional application No. 61/384,773, filed on Sep. 21, 2010.

(51) Int. Cl. G06F 17/00

(52) U.S. Cl. 715/211

(57) ABSTRACT

An online document processor can redraw a document asynchronously upon receiving a download or edit command. After receiving a download command, the document processor downloads a portion of the document to user equipment, redraws the portion, downloads another portion, and determines whether a new edit command has been received. The document processor allocates time intervals for downloading new portions, redrawing previously downloaded portions, and receiving new edit commands. After receiving an edit command, the document processor selects one of several redraw operations. For edit operations in which the document display needs to be updated before a new edit operation can be processed, only the portion of the document up to the displayed portion of the document is redrawn. For other edit operations, the document processor operates in a time division multiplex mode in which time intervals for receiving new edit commands are alternated with time intervals for performing redraw operations.

This application claims the benefit of U.S. Provisional Application No. 61/384,773 filed Sep. 21, 2010, which is incorporated herein by reference.

### BACKGROUND

The present disclosure relates generally to online document processors, and more particularly to asynchronous redrawing in online document processors.

Various system architectures have been developed for users to access computer applications, such as word processors, spreadsheets, and drawing programs. In one architecture, applications software is loaded onto a personal computer accessed by a single user. For multiple users, each user has an individual personal computer, and individual copies of applications software are loaded onto each personal computer. In another architecture, applications software is loaded onto an applications server connected to a communications network. Multiple users can simultaneously access the applications server via the communications network.

Widespread deployment of the Internet has accelerated developments in cloud computing, in which applications are viewed as online services provided by an applications services provider. Details of software and hardware are transparent to the user. A user accesses the Internet via a communications device, such as a personal computer, and, using a web browser, logs onto the website of an applications services provider. The user then launches an application such as a word processor.

The user provides input to the application and receives output from the application via a graphical user interface. In response to user input, the application performs certain operations. Web browsers are typically single threaded. While the application is performing certain operations, the user can be blocked from entering further input. If the hold time is too long, the user experience can be unsatisfactory. What are needed are methods and apparatus for reducing the hold time for online applications.

### BRIEF SUMMARY

A user accesses an online document processor via user equipment and a communications network. The user provides input to and receives output from the online document processor via a web browser and a graphical user interface viewed on a video display. When the online document processor receives a download command or an edit command, the online document processor redraws the document to generate a specified graphical layout. During a synchronous redraw operation, the entire redraw operation needs to be completed before the online document processor accepts further user input. In embodiments disclosed herein, certain redraw operations are performed asynchronously. These redraw operations can be interrupted prior to completion, and new user input can be accepted.

Downloading a document refers to the operation of transmitting the document from an application server to user equipment. The downloading process is controlled by the online document processor in response to receiving a user command. The operation of redrawing a document refers to the operation of formatting the layout of the document. The redraw operation is performed by the online document processor. The layout of the document includes graphical characteristics such as margins, pagination, line spacing, fonts, bolding, underlining, headers, footers, comments, drawings, and images. Redrawing a document includes the first instance in which a document is drawn.

Edit operations include operations that change the contents of the document and operations that change the layout of the document. Edit operations also include operations that change the displayed portion of the document, but not the content or layout of the document; for example, scrolling through a document is considered to be an edit operation. Printing a document is also considered to be an edit operation.

In a first configuration, a document has been previously stored on an applications server. In response to receiving a download command, the online document processor downloads a first portion of the document to user equipment, redraws the first portion of the document, and then downloads a second portion of the document. In one embodiment, the first portion of the document ends at a location determined by a sum of a document end-of-display point and a buffer length; the buffer length is greater than or equal to zero. After downloading the second portion of the document has been completed, the online document processor waits for a maximum of a first predetermined time interval for an edit command to be received. If an edit command is received within the first predetermined time interval, then the online document processor executes the edit command. If an edit command is not received within the first predetermined time interval, then the online document processor proceeds to redraw at least a part of the second portion of the document.

In one embodiment, time intervals for receiving edit commands are alternated with time intervals for performing downloading and redrawing operations. If no edit command is received within the first predetermined time interval, redrawing at least a part of the second portion of the document is performed for a maximum of a second predetermined time interval. The online document processor then waits for a maximum of a third predetermined time interval for receipt of an edit command.

In one embodiment, in response to receiving an edit command, the online document processor performs one of the following redraw operations:

(a) Redrawing the first portion of the document and the second portion of the document;

(b) Downloading a third portion of the document, in which the third portion includes the remaining portion of the document not previously downloaded, and redrawing the entire document;

(c) Redrawing a third portion of the document, in which the third portion of the document ends at a location determined by a sum of a document end-of-display point and a buffer length;

(d) Redrawing a third portion of the document, in which the third portion of the document ends at a location determined by a sum of a document scroll point and a buffer length; and

(e) Redrawing a third portion of the document, in which the third portion ends at a location determined by a sum of a document spacer index and a buffer length.

The buffer length referred to in the above operations is greater than or equal to zero.

In a second configuration, a new document or a previously downloaded document is edited by an online document processor. In response to receiving an edit command, the online document processor selects one of several redraw operations. For edit commands in which the document display needs to be updated before a new edit command can be processed, the portion of the document up to and including a specified location (plus a buffer length) is redrawn. For other edit commands, the online document processor operates in a time division multiplex mode in which time intervals for receiving new edit commands are alternated with time intervals for performing redraw operations.

Redraw operations for edit commands in which the document display needs to be updated before a new edit command can be processed include the following redraw operations:

(a) Redrawing the entire document;

(b) Redrawing a portion of the document, in which the portion of the document ends at a location determined by a sum of a document end-of-display point and a buffer length;

(c) Redrawing a portion of the document, in which the portion of the document ends at a location determined by a sum of a document scroll point and a buffer length; and

(d) Redrawing a portion of the document, in which the portion ends at a location determined by a sum of a document spacer index and a buffer length.

The buffer length referred to in the above operations is greater than or equal to zero.

This disclosure discloses methods for performing embodiments of the redraw operations, computer readable media storing computer program instructions defining steps for performing embodiments of the redraw operations, and applications servers configured to execute computer program instructions defining steps for performing embodiments of the redraw operations.

This disclosure further discloses at least the following apparatus: (1) An apparatus for redrawing with an online document processor a document stored on an applications server, wherein the apparatus comprises: (a) means for receiving a download command; (b) means for downloading a first portion of the document; (c) means for redrawing the first portion of the document; (d) means for downloading a second portion of the document; (e) means for, in response to receiving an edit command within a predetermined time interval starting from completion of the downloading of the second portion of the document, executing the received edit command; and (f) means for, in response to not receiving an edit command within the predetermined time interval, redrawing at least a part of the second portion of the document. (2) An apparatus for redrawing a document with an online document processor, wherein the apparatus comprises: (a) means for receiving an edit command; and (b) means for, based on the received edit command, (i) redrawing the entire document; (ii) redrawing a portion of the document, the portion ending at a location determined by a sum of a document end-of-display point and a buffer length, wherein the buffer length is greater than or equal to zero; (iii) redrawing a portion of the document, the portion ending at a location determined by a sum of a document scroll point and a buffer length, wherein the buffer length is greater than or equal to zero; (iv) redrawing a portion of the document, the portion ending at a location determined by a sum of a document spacer index and a buffer length, wherein the buffer length is greater than or equal to zero; or (v) redrawing a portion of the document for a maximum of a predetermined time interval.

These and other advantages of the disclosure will be apparent to those of ordinary skill in the art by reference to the following detailed description and the accompanying drawings.

### BRIEF DESCRIPTION OF THE DRAWINGS

FIG. 1 shows an embodiment of a system for providing online applications services;

FIG. 2 shows an embodiment of user equipment;

FIG. 3 shows an embodiment of a graphical user interface;

FIG. 4 shows an embodiment of an applications window;

FIG. 5A and FIG. 5B illustrate character, string, and block edit operations;

FIG. 6A and FIG. 6B illustrate a scroll operation;

FIG. 7A and FIG. 7B illustrate a spacer index operation;

FIG. 8A and FIG. 8B illustrate a global edit operation;

FIG. 9A and FIG. 9B illustrate a change view operation;

FIG. 10A and FIG. 10B illustrate an image insertion operation;

FIG. 11A-FIG. 11D show a flowchart of an embodiment of a method for asynchronous redrawing on download;

FIG. 12A-FIG. 12C show a flowchart of an embodiment of a method for asynchronous redrawing on edit of a document previously downloaded and redrawn; and

FIG. 13 shows an embodiment of a computational system for implementing a document processor.

### DETAILED DESCRIPTION

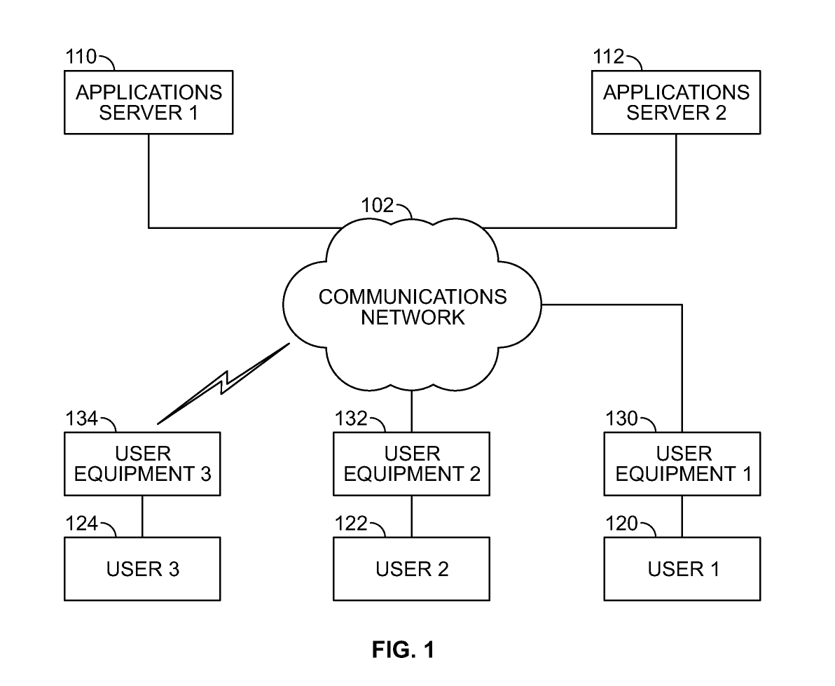

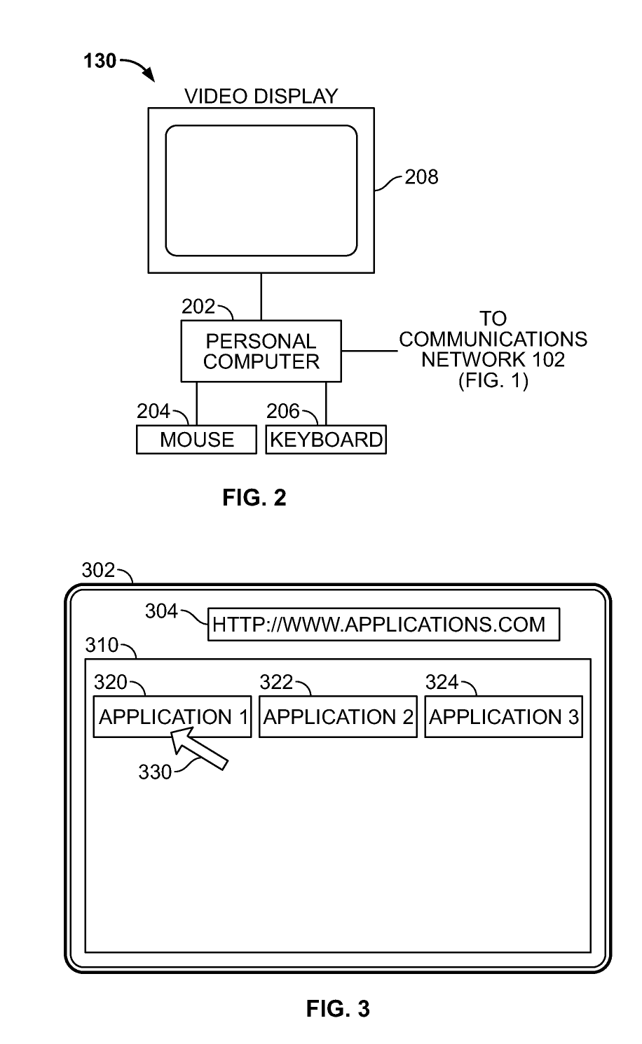

FIG. 1 shows an embodiment of a system for providing online applications services. Computer applications are loaded onto one or more applications servers, such as applications server 1 110 and applications server 2 112. The applications servers communicate with communications network 102. Examples of communications network 102 include circuit-switched and packet-switched networks, public or private. In one embodiment, communications network 102 represents the global Internet.

One or more users, such as user 1 120-user 3 124, access applications server 1 110 and applications server 2 112 via user equipment, such as user equipment 1 130-user equipment 3 134, respectively, that communicate with communications network 102. Examples of user equipment include personal computers, laptop computers, personal digital assistants, and cell phones. The communications links can be wired or wireless. In the example shown in FIG. 1, user equipment 1 130 and user equipment 2 132 are personal computers that communicate with communications network 102 over wired links, and user equipment 3 134 is a laptop computer, outfitted with a wireless modem, that communicates with communications network 102 over a wireless link.

FIG. 2 shows an embodiment of user equipment. User equipment 1 130 in FIG. 1 is shown as an example. Personal computer 202 communicates with communications network 102. A user provides input to personal computer 202 via a user input device, such as mouse 204, keyboard 206, or video display 208 (equipped with a touch screen, for example). Personal computer 202 provides user output via video display 208. Personal computer 202 can also provide user output via other user output devices, such as a printer (not shown).

FIG. 3 shows an embodiment of a graphical user interface. The graphical user interface is displayed on video display 208. A user launches a web browser in web browser window 302 and enters the uniform resource locator (URL) of an applications services provider in URL field 304. In this example, the URL is referenced as www.applications.com. The website of the applications services provider is displayed in website window 310. Presented in website window 310 are three icons (icon 320, icon 322, and icon 324), that represent application 1, application 2, and application 3, respectively. A user selects a particular application by using mouse 204 to position a cursor 330 over a particular icon. In the example shown in FIG. 3, the user selects icon 320 and double-clicks mouse 204 to launch application 1.

Examples of typical applications include word processors, spreadsheets, presentation programs, and drawing programs. The distinction between various types of applications has blurred since several functions can be commingled in a single application. For example, pictures can be inserted into a page of text, and some word processors have integral drawing programs. Furthermore, word processors, spreadsheets, presentation programs, and drawing programs can be embedded into one another. For example, a spreadsheet or drawing program can be embedded in a word processor, and the spreadsheet or drawing program can be launched from within the word processor.

Herein, a document processor refers to a computer application that receives, as user input, text or a combination of text and graphical elements; performs a user-specified operation or set of operations on the user input; and generates, as user output, text or a combination of text and graphical elements. The user output is referred to as a document. In an embodiment, a document is stored as a computer file. Portions of, or the entirety of, a document can be displayed on a video display or printed on a printer.

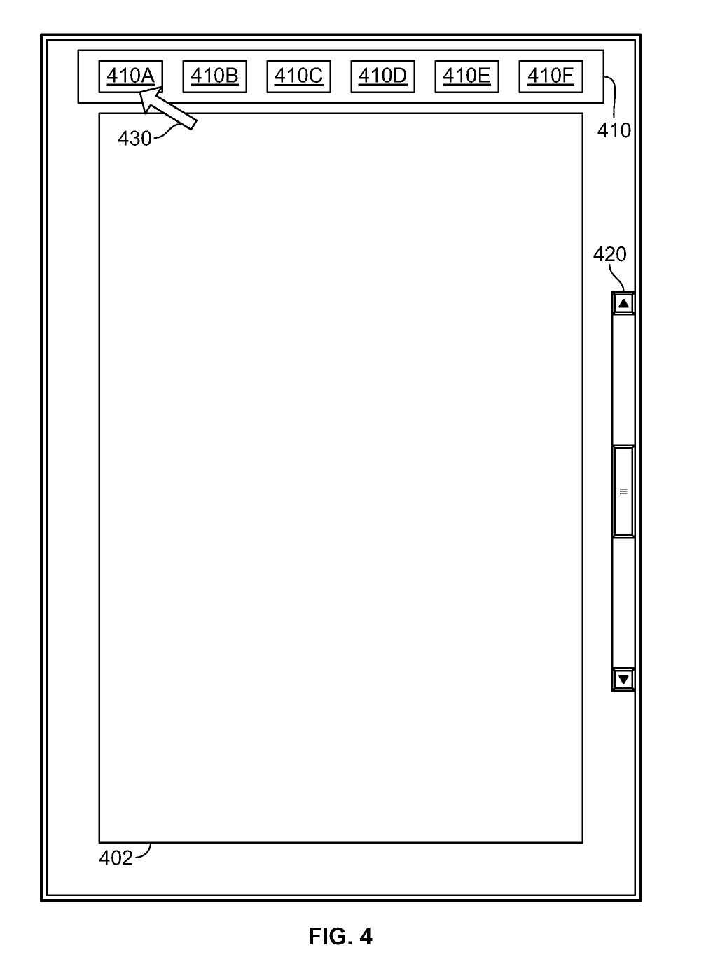

In an embodiment, application 1 is a document processor. When application 1 is launched, an applications window is opened. FIG. 4 shows an embodiment of an applications window. Shown are three representative fields. Display field 402 displays contents of a document. Scroll bar 420 controls the portion of the document displayed in display field 402. Toolbar 410 includes multiple virtual function keys, referenced as virtual function key 410A-virtual function key 410F. Common examples of virtual function keys include “File”, “Edit”, “View”, “Insert”, “Tools”, and “Table”. A user selects a virtual function key, for example, by using mouse 204 (FIG. 2) to position cursor 430 over it and executes the corresponding function by clicking or double-clicking the mouse.

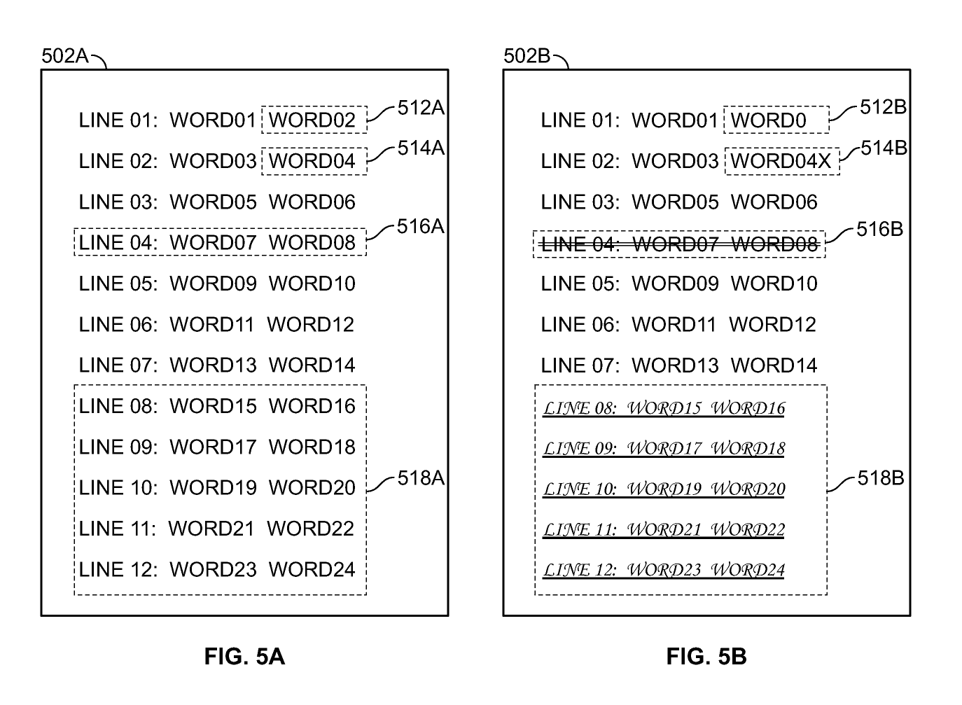

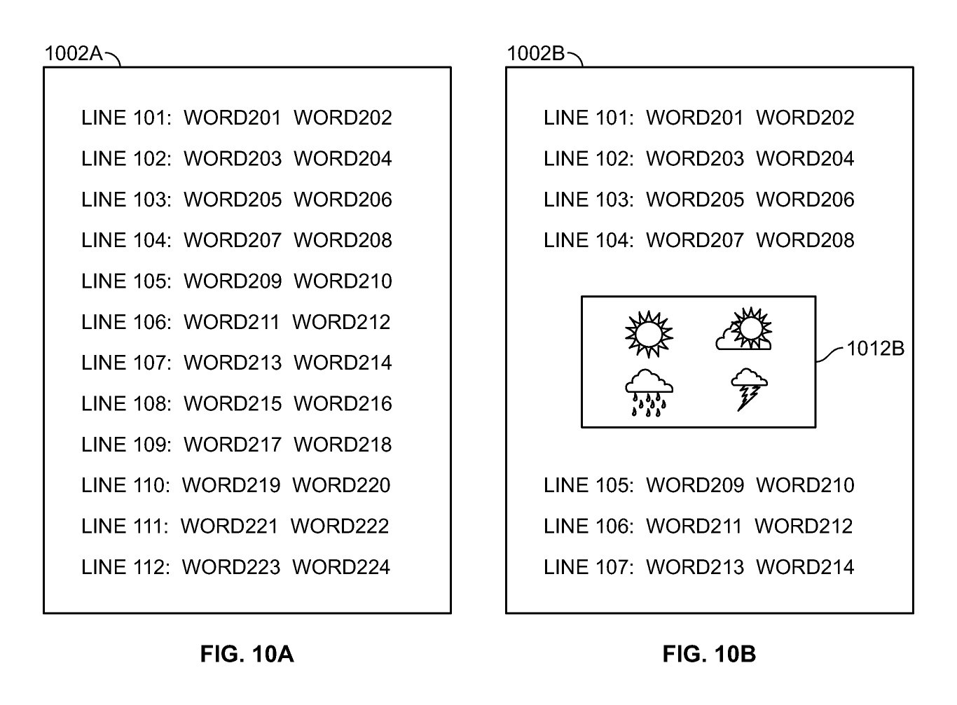

The following sets of figures [(FIG. 5A, FIG. 5B)-(FIG. 10A, FIG. 10B)] show display screens of various edit operations. Herein, edit operations include operations that change the contents of the document and operations that change the layout of the document. Herein, edit operations also include operations that change the displayed portion of the document, but not the content or layout of the document; for example, scrolling through a document is considered to be an edit operation. Printing a document is also considered to be an edit operation. In each set of figures, the “A” view shows the initial view of the document, and the “B” view shows the view of the document after an edit operation has been performed.

FIG. 5A and FIG. 5B illustrate character, string, and block edit operations. In FIG. 5A and FIG. 5B, the dashed rectangles are shown only to reference specific features and are not part of the displays. Single character edits are illustrated by comparing word 512A in view 502A to word 512B in view 502B (deletion of the character “2”) and by comparing word 514A in view 502A to word 514B in view 502B (insertion of character “X”). String edits are illustrated by comparing string 516A in view 502A to string 516B in view 502B (double strikethrough of all characters in the string). Block edits are illustrated by comparing block 518A in view 502A to block 518B in view 502B (reformatting the font and style within the block). Note that a block can include a substantial portion, or even the entirety, of a document.

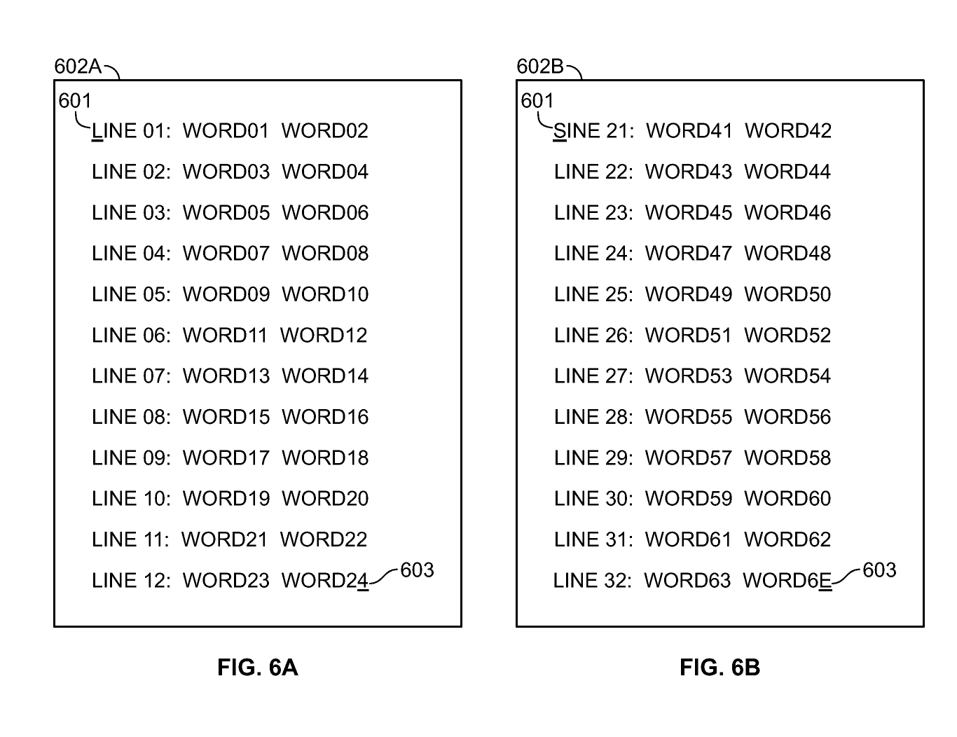

FIG. 6A and FIG. 6B illustrate a scroll operation. In view 602A, “LINE 01-LINE 12” of the document are displayed. After the scroll operation, “LINE 21-LINE 32” of the document are displayed in view 602B. Note: The typographical errors in FIG. 6B (the incorrect “SINE 21” instead of the correct “LINE 21” and the incorrect “WORD6E” instead of the correct “WORD64”) are intentional and are discussed below.

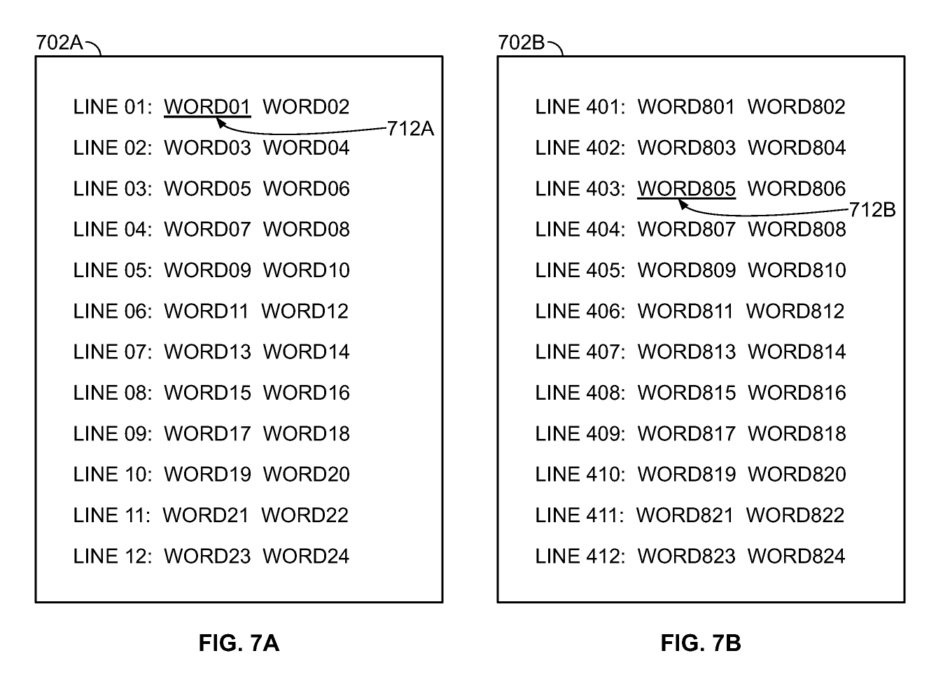

FIG. 7A and FIG. 7B illustrate a spacer index operation. Herein, a spacer index refers to a user-specified reference location within a document. A spacer index, for example, can be indicated by the position of a cursor on a display. In view 702A, “LINE 01-LINE 12” of the document are displayed. Spacer index 712A is located at “WORD01” in “LINE 01”. In this example, “WORD01” has an embedded hypertext link. The user clicks on “WORD01”, and the spacer index jumps to spacer index 712B located at “WORD805” in “LINE 403” in view 702B. Other operations can cause the spacer index to jump. For example, if the document supports bookmarks, clicking on a bookmark will cause the spacer index to jump to the location of the bookmark. The display shows a portion of the document in the neighborhood of the bookmark. In the examples above, the spacer index referred to a location of a word. In general, the resolution of a spacer index can be finer; for example, the location of a character or a graphical element.

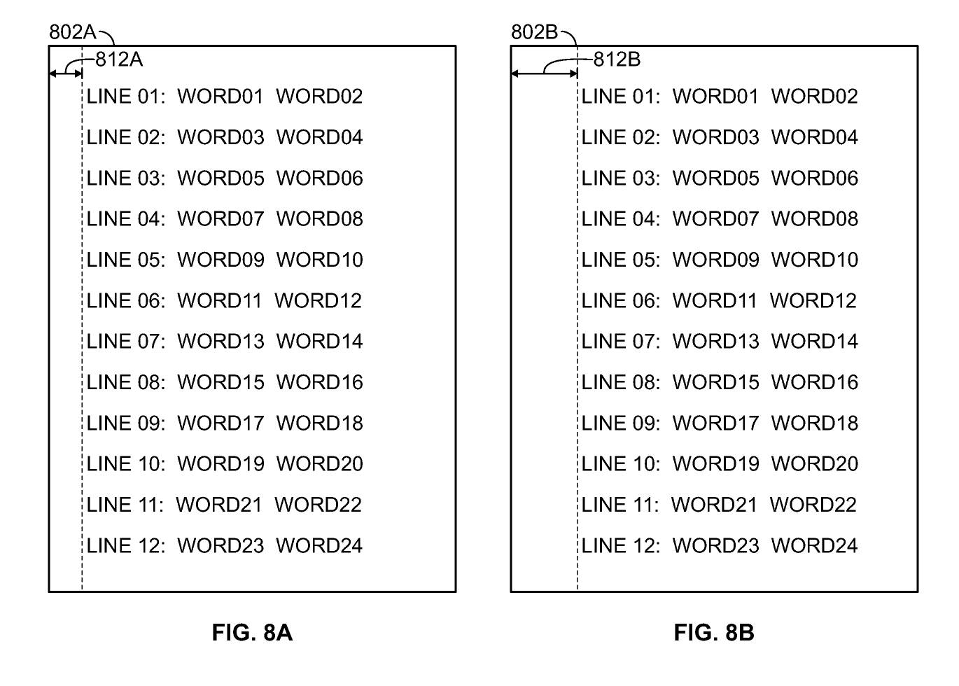

FIG. 8A and FIG. 8B illustrate a global edit operation. In view 802A, the margin is set at margin 812A. In view 802B, the margin has been reset to margin 812B. In this example, the margin has been reset globally for the entire document. In another example of a global operation, the font of the entire document is changed from “Arial” to “Times Roman”.

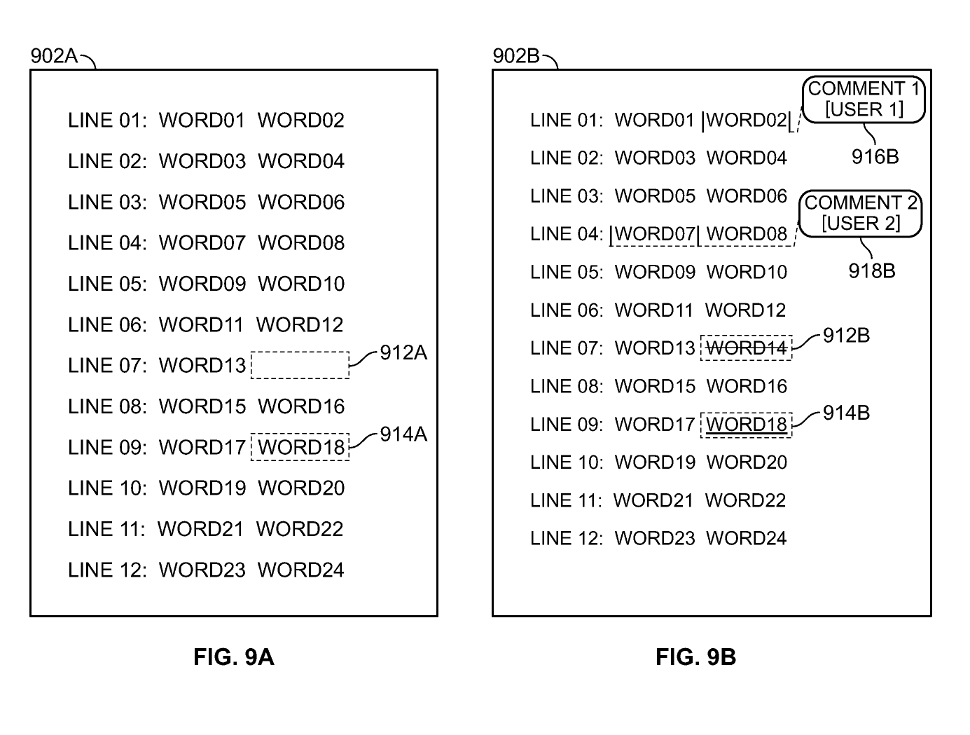

FIG. 9A and FIG. 9B illustrate a change view operation. In view 902A, the “View Markup” feature is turned off; in view 902B, the “View Markup” feature is turned on. The “View Markup” feature displays changes in the current version of the document with respect to a previous version of the document; in some document processors, the “View Markup” feature also displays comments. Word 912A in view 902A was previously deleted; the deleted word is indicated as word 912B (“WORD14”) in view 902B. Word 914A (“WORD18”) in view 902A was previously added; the added word is indicated as word 914B (“WORD18”) in view 902B. Also shown in view 902B are comment 1 916B from user 1 and comment 918B from user 2.

FIG. 10A and FIG. 10B illustrate an image insertion operation. In view 1002A, “LINE 101-LINE 112” of the document are displayed. In view 1002B, image 1012B has been inserted after “LINE 104”. Consequently, the portion of the document from “LINE 105” on is pushed down, affecting subsequent pagination.

In an embodiment, a document has been previously created and stored on an online document processor. To edit the document, the online document processor first downloads the document to user equipment. Herein, downloading a document refers to transmitting the document from an application server to user equipment. The downloading process is controlled by the online document processor in response to receiving a user command. With a single-threaded browser, the user cannot perform edit operations on the document during the downloading process. If the document length is substantial, or if the document has complex contents (such as images), the download time can be substantial, and the user experience can be unsatisfactory. In common operation, the entire document is first downloaded. The entire document is then redrawn, and a portion of the document is displayed. The user then proceeds to edit the document.

Herein, the operation of redrawing a document refers to the operation of formatting the layout of the document. The redrawing operation is performed by the online document processor. The layout of the document includes graphical characteristics such as margins, pagination, line spacing, fonts, bolding, underlining, headers, footers, comments, drawings, and images. Herein, redrawing a document includes the first instance in which a document is drawn.

In a synchronous redrawing operation, the document is redrawn upon receiving a user command that requires a redrawing operation. During the redrawing operation, a new user command cannot be processed. A new user command is processed only upon completion of the redrawing operation. Embodiments of redrawing operations described below perform asynchronous redrawing operations. In an asynchronous redrawing operation, a portion of a redrawing operation can be delayed or interrupted. A new user command can be processed before the redrawing operation has been completed, and the redrawing operation can be completed at a later time.

In an embodiment, the location within a document is determined with respect to the beginning (also referred to as the top) of the document. The portion of the document between the top of the document and a location of interest is referred to as a portion of the document above the location of interest. The portion of the document between the location of interest and the end (also referred to as the bottom) of the document is referred to as a portion of the document below the location of interest.

In an embodiment, a portion of interest of a document is displayed in a display field at a particular time of interest. The layout of the displayed portion of interest is determined both by the layout of the displayed portion of interest and the layout of the portion of the document above the displayed portion of interest (for example, changes in margins can change pagination). The layout of the displayed portion of interest is not affected by the layout of the portion of the document below the displayed portion of interest.

Herein, a location in the display field is mapped to a location in the displayed portion of the document, and a location in the displayed portion of the document is mapped to a location in the display field. Herein, a location in the document is referred to as a document location, and a location in the display field is referred to as a display location.

For example, refer back to FIG. 6A and FIG. 6B. In FIG. 6A and FIG. 6B, the display location referred to as the display start-of-display point 601 and the display location referred to as the display end-of-display point 603 delimit the display field (which is rectangular in this instance). In FIG. 6A, the display start-of-display point 601 is mapped to the document start-of-display point corresponding to the character “L” at the beginning of LINE 01, and display end-of-display point 603 is mapped to the document end-of-display point corresponding to the character “4” at the end of LINE 12. In FIG. 6B, after the scroll operation, display start-of-display point 601 is mapped to the document start-of-display point corresponding to the character “S” at the beginning of LINE 21, and display end-of-display point 603 is mapped to the document end-of-display point corresponding to the character “E” at the end of LINE 32.

Mapping between a document location and a display location can be performed by various methods. In an embodiment, the document includes only lines of text. The online document processor stores the height (in pixels) of every document line of text. The online document processor receives from the web browser the height (in pixels) of the display field. When the document is downloaded, the number of document lines mapped to the display field is calculated from the height of the display field and the height of each document line.

During a scroll operation, the online document processor tracks how far down from the top of the document the user has scrolled. The document line mapped to the top of the display field is determined by summing the heights of all the lines from the top of the document until the sum of the heights equals the distance that has been scrolled. The document line mapped to the bottom of the display field is determined by adding document lines to the document line mapped to the top of the display field until the sum of the heights of the additional document lines equals the height of the display field. One skilled in the art can implement similar methods for documents including graphical elements.

In general, a user performs edit operations based on the displayed portion of interest. As discussed above, with a single-threaded browser, a user cannot enter new user input while the document is being downloaded or redrawn. To reduce the hold time between user inputs, embodiments initially process only those portions of the document that affect the displayed portion of interest. Processing of the portions below the displayed portion of interest are deferred.

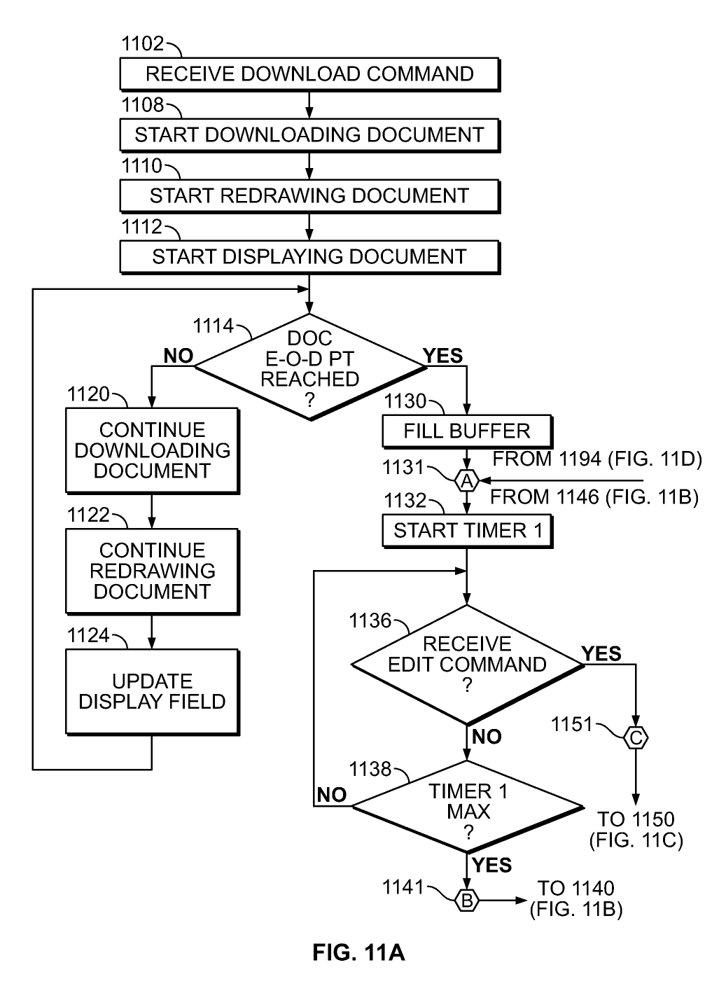

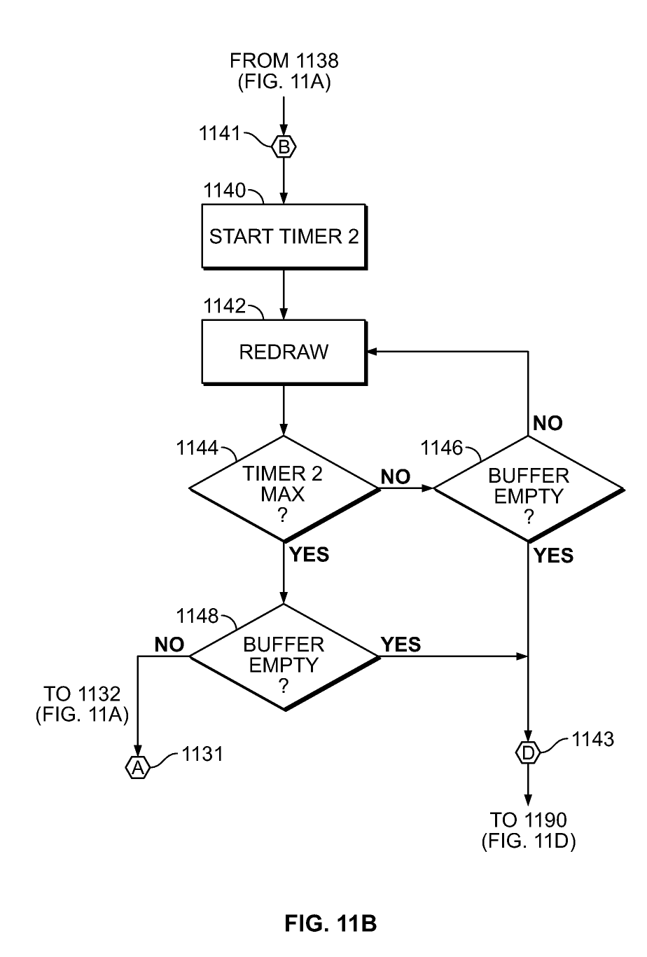

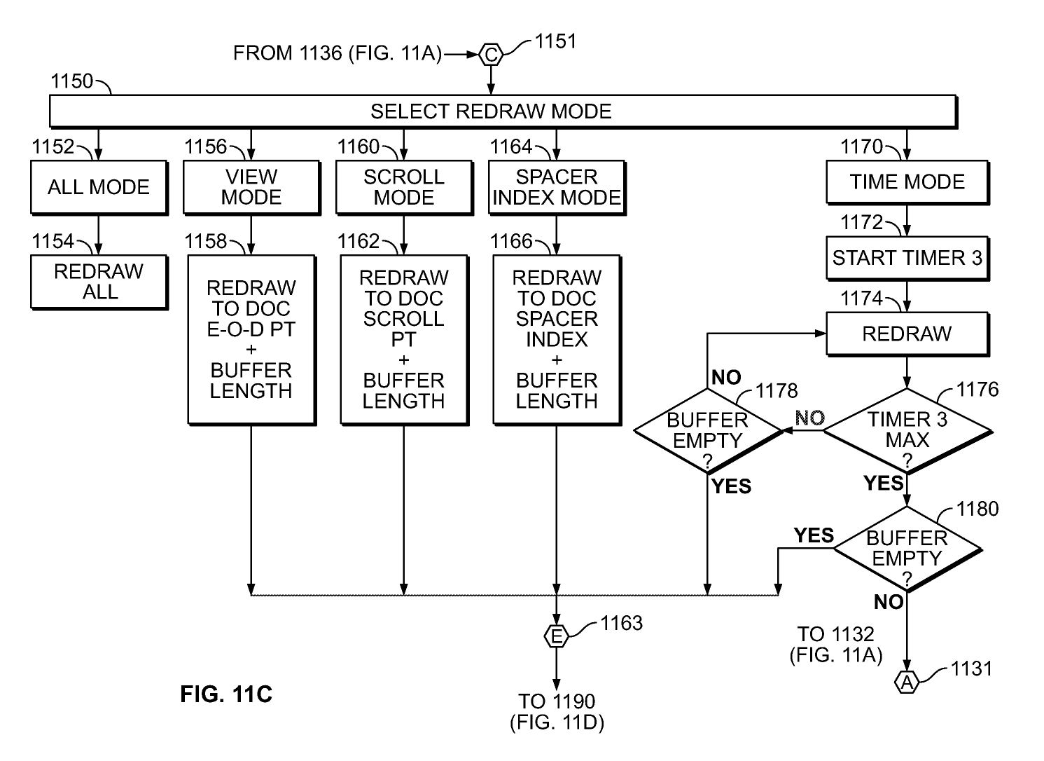

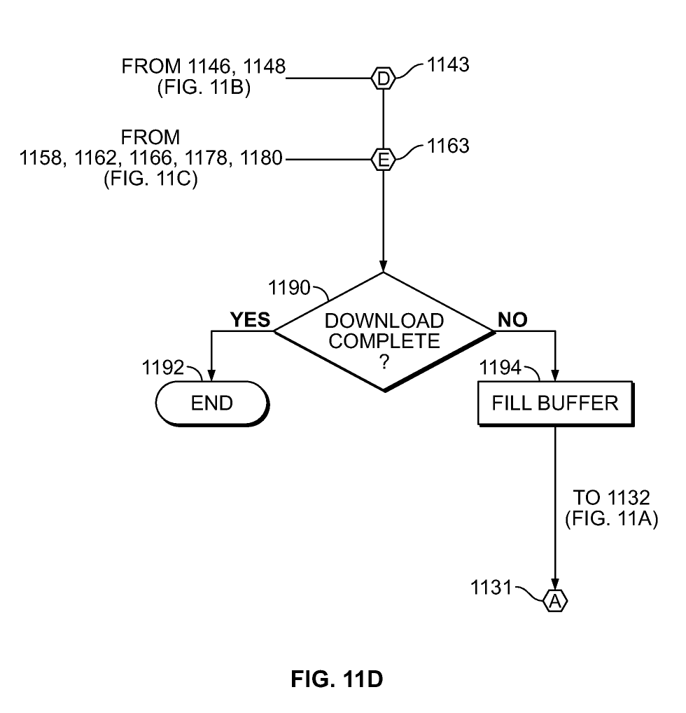

FIG. 11A-FIG. 11D show a flowchart of an embodiment of a method for asynchronous redrawing on initial download. A previously created document is stored on an applications server, and a user accesses an online document processor to edit the document. Reference marks shown as an alphabetical character inside a hexagon are used to maintain continuity among FIG. 11A-FIG. 11D. The reference marks are reference mark A 1131, reference mark B 1141, reference mark C 1151, reference mark D 1143, and reference mark E 1163. The reference marks are shown in the figures as visual aids but are not explicitly included in the description below.

Refer to FIG. 11A. In block 1102, the online document processor receives a download command. The process then passes to block 1108, in which downloading of the document is started. The process then passes to block 1110, in which redrawing of the document is started, and then to block 1112, in which display of the document is started.

The process then passes to block 1114, in which the document location at the end of the redrawn portion is compared to the document end-of-display point (DOC E-O-D PT). As discussed above, the document end-of-display point is the location in the document mapped to the display end-of-display point in the display field of a user's video display. If the document end-of-display point has not been reached, then the process passes to block 1120, in which downloading of the document is continued. The process then passes to block 1122, in which redrawing of the document is continued, and then to block 1124, in which the display field is updated.

The process then returns to block 1114. If the document end-of-display point has been reached, then the process passes to block 1130, in which downloading is continued until a buffer is filled. The size of a buffer is specified by a buffer length. In an embodiment, the buffer length corresponds to a number of lines in the document or to the number of lines equivalent to the space occupied by a graphical object such as an image. In an embodiment, a buffer size sufficient to hold one or two nominal paragraphs is used.

The process then passes to block 1132, in which a timer 1 is started. The process then passes to block 1136, in which receipt of an edit command is determined. If no edit command has been received, then the process passes to block 1138, in which the elapsed time is determined and compared to a predetermined maximum time T1MAX. Herein, a timer expires when the elapsed time from the start of the timer reaches a predetermined maximum time. If the elapsed time is less than T1MAX, then the process returns to block 1136. One skilled in the art can set the value of the predetermined maximum time T1MAX (and the values of the predetermined maximum time T2MAX and predetermined maximum time T3MAX, described below) to provide an appropriate balance between the time allocated for receiving an edit command and the time allocated for performing a redraw operation. Further consideration of time intervals is discussed below.

If the elapsed time is greater than or equal to T1MAX, then the process passes to block 1140 (FIG. 11B), in which a timer 2 is started. The process then passes to block 1142, in which redrawing of the contents of the buffer is started. The process then passes to block 1144, in which the elapsed time is determined and compared to a predetermined maximum time T2MAX. If the elapsed time is less than T2MAX, then the process passes to block 1146, in which the state of the buffer (empty or not empty) is determined. If the buffer is not empty, then the process returns to block 1142. If the buffer is empty, then the process passes to block 1190 (FIG. 11D), described below.

Now refer back to block 1144. If the elapsed time is greater than or equal to T2MAX, then the process passes to block 1148, in which the state of the buffer is determined. If the buffer is empty, then the process passes to block 1190 (FIG. 11D), described below. If the buffer is not empty, then the process returns to block 1132 (FIG. 11A), and a new timer 1 is started.

Refer to FIG. 11D. In block 1190, the state of the download (download completed or not completed) is determined. If the download has been completed (that is, the entire document has been downloaded), then the process ends in block 1192. If the download has not been completed, then the process passes to block 1194, in which a buffer is filled (that is, another portion of the document is downloaded). The buffer size in step 1194 can be the same as or different from the buffer size in step 1130 (FIG. 11A). The process then returns to block 1132 (FIG. 11A), and a new timer 1 is started.

Now refer back to block 1136 in FIG. 11A. If an edit command has been received, then the process passes to block 1150 in FIG. 11C. Based on the received edit command, one of the following redraw operation modes is selected: all mode 1152, view mode 1156, scroll mode 1160, spacer index mode 1164, or time mode 1170. The all mode is selected, for example, when the user issues a command to print the entire document. The view mode is selected, for example, for the edit operation previously shown in (FIG. 9A, FIG. 9B). The scroll mode is selected, for example, for the edit operation previously shown in (FIG. 6A, FIG. 6B). The spacer index mode is selected, for example, for the edit operation previously shown in (FIG. 7A, FIG. 7B). The time mode is selected, for example, for the edit operation previously shown in (FIG. 8A, FIG. 8B).

The view, scroll, and spacer index modes are used to provide the highest priority for the redraw operation. The displayed portion of the document needs to be up-to-date before the user enters the next edit command. The time mode is used when the entire redraw operation does not to be completed before the user enters the next edit command. For example, a global reset of the margins of a long, complex document can require substantial processing time. Once the margins up to and including the portion of interest have been reset, however, resetting the margins on the remaining portion of the document can be deferred.

In the time mode, the document processor operates in a time division multiplex mode. The document processor performs a sequence of operations in which a time interval (referred to herein as an edit time interval) for accepting an edit command is alternated with a time interval (referred to herein as a redraw time interval) for performing a redraw operation. The edit time interval and the redraw time interval can both be independently set. In some embodiments, the edit time interval is equal to the redraw time interval. In other embodiments, the edit time interval is not equal to the redraw time interval. If the hold time that the user needs to wait between entries of consecutive edit commands is less than a maximum value, the user experience is satisfactory. In an embodiment, the maximum value is approximately 200 milliseconds.

Refer now back to block 1152. If the all mode 1152 is selected, then the process passes to block 1154, in which all of the downloaded portion of the document is redrawn. In some instances, the remaining portion of the document (that is, the portion of the document that has not yet been downloaded) is downloaded, and the entire document is redrawn.

If the view mode 1156 is selected, then the process passes to block 1158, in which the portion of the document up to and including the document end-of-display point is redrawn. An additional portion of the document below the document end-of-display point can be redrawn as a buffer. In general, in the view mode, the portion of the document redrawn ends at the document end-of-display point plus a buffer length, where the buffer length is greater than or equal to zero. The process then passes to block 1190 (FIG. 11D), described above.

If the scroll mode 1160 is selected, then the process passes to block 1162, in which the portion of the document up to and including a document scroll point (DOC SCROLL PT) is redrawn. The document scroll point is a location in the displayed portion of the document mapped to a location in the display field upon completion of a scroll operation. The document scroll point can be the same as the document end-of-display point. An additional portion of the document below the document scroll point can be redrawn as a buffer. In general, in the scroll mode, the portion of the document redrawn ends at the document scroll point plus a buffer length, where the buffer length is greater than or equal to zero. The process then passes to block 1190 (FIG. 11D), described above.

If the spacer index mode 1164 is selected, then the process passes to block 1166, in which the portion of the document up to and including a document spacer index is redrawn. Spacer indexes were previously described in reference to FIG. 7A and FIG. 7B. An additional portion of the document below the document spacer index can be redrawn as a buffer. In general, in the spacer index mode, the portion of the document redrawn ends at the document spacer index plus a buffer length, where the buffer length is greater than or equal to zero. The process then passes to block 1190 (FIG. 11D), described above.

If the time mode 1170 is selected, then the process passes to block 1172, in which a timer 3 is started. The process then passes to block 1174, in which redrawing of the contents of the buffer is started. The process then passes to block 1176, in which the elapsed time is determined and compared to a predetermined maximum time T3MAX. If the elapsed time is less than T3MAX, then the process passes to block 1178, in which the state of the buffer is determined. If the buffer is not empty, then the process returns to block 1174. If the buffer is empty, then the process passes to block 1190 (FIG. 11D), described above.

Now refer back to block 1176. If the elapsed time is greater than or equal to T3MAX, then the process passes to block 1180, in which the state of the buffer is determined. If the buffer is empty, then the process passes to block 1190 (FIG. 11D), described above. If the buffer is not empty, then the process returns to block 1132 (FIG. 11A), and a new timer 1 is started.

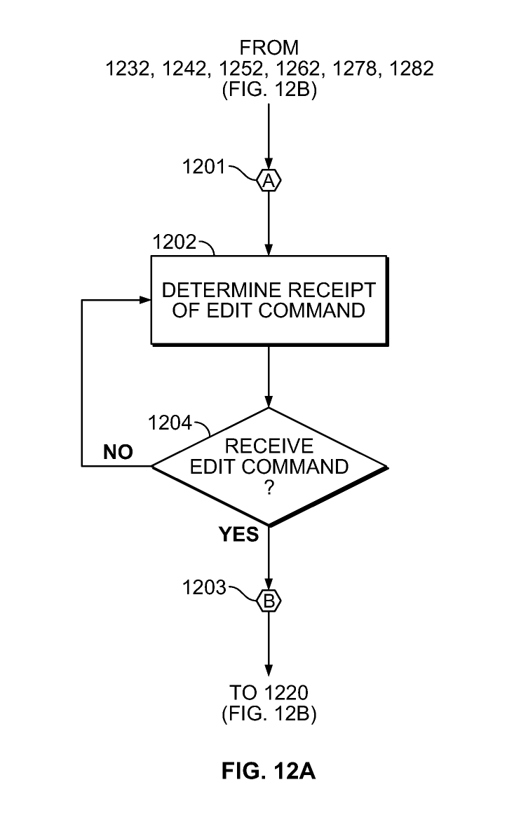

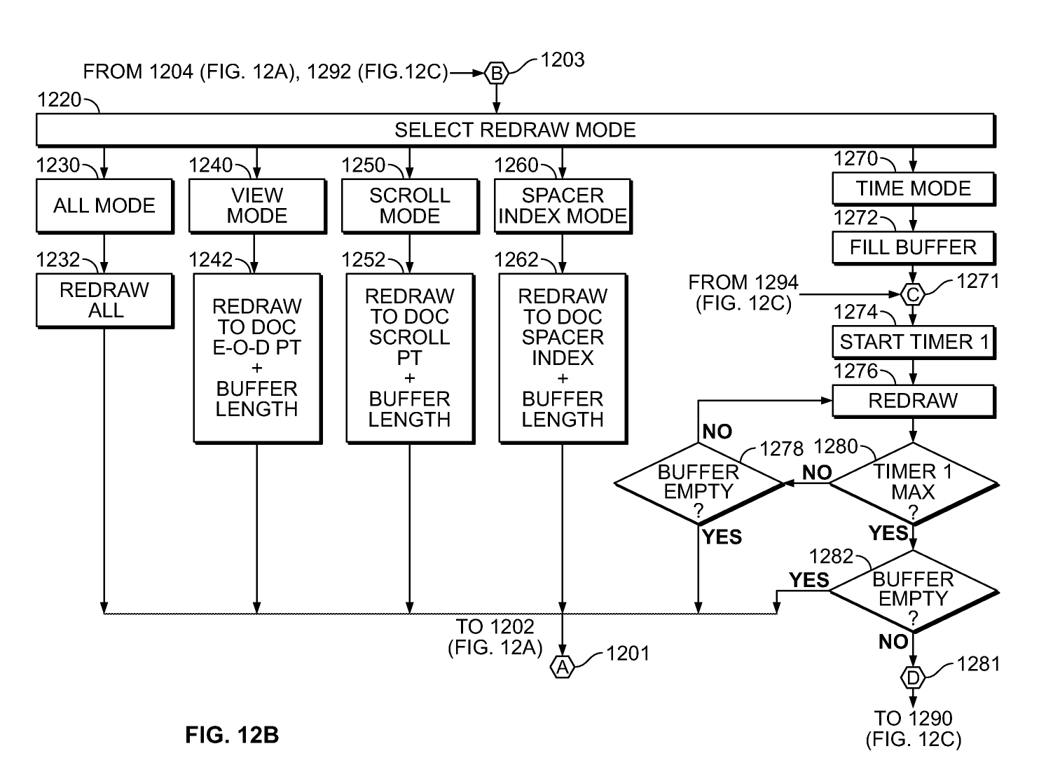

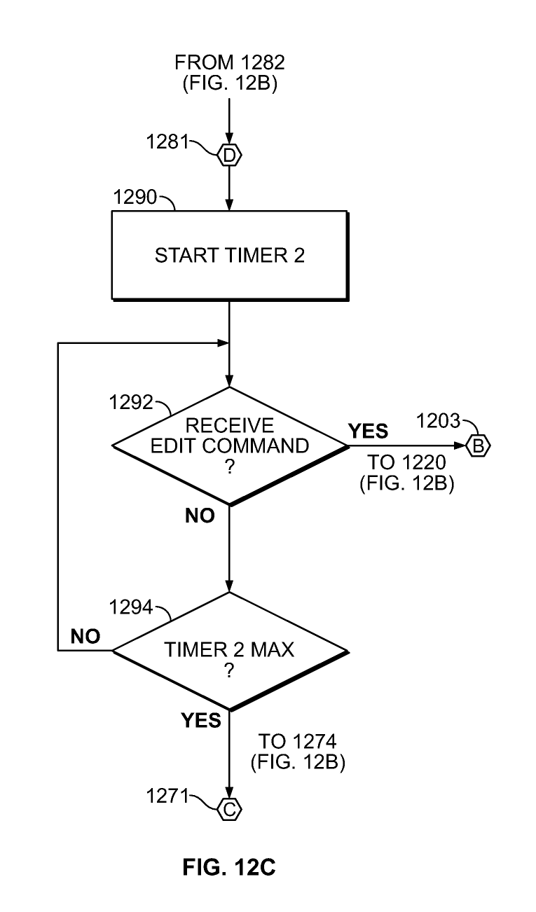

FIG. 12A-FIG. 12C show a flowchart of an embodiment of a method for asynchronous redrawing on edit of a document by an online document processor. The document can either be a new document or a document previously downloaded from an applications server and redrawn by the online document processor. As previously discussed with respect to FIG. 11A-FIG. 11D, reference marks are shown in FIG. 12A-FIG. 12C as visual aids but are not explicitly included in the description below. The reference marks are reference mark A 1201, reference mark B 1203, reference mark C 1271, and reference mark D 1281.

Refer to FIG. 12A. In block 1202, the online document processor determines whether an edit command has been received. The process then passes to block 1204. If an edit command has not been received, then the process returns to block 1202. If an edit command has been received, then the process passes to block 1220 (FIG. 12B). Based on the received edit command, one of the following redraw operation modes is selected: all mode 1230, view mode 1240, scroll mode 1250, spacer index mode 1260, or time mode 1270.

If the all mode 1230 is selected, then the process passes to block 1232, in which all of the document (the entire document) is redrawn. The process then returns to block 1202 (FIG. 12A).

If the view mode 1240 is selected, then the process passes to block 1242, in which the portion of the document up to and including the document end-of-display point is redrawn. An additional portion of the document below the document end-of-display point can be redrawn as a buffer. In general, in the view mode, the portion of the document redrawn ends at the document end-of-display point plus a buffer length, where the buffer length is greater than or equal to zero. The process then returns to block 1202 (FIG. 12A).

If the scroll mode 1250 is selected, then the process passes to block 1252, in which the portion of the document up to and including a document scroll point (DOC SCROLL PT) is redrawn. The document scroll point is a location in the displayed portion of the document mapped to a location in the display field upon completion of a scroll operation. The document scroll point can be the same as the document end-of-display point. An additional portion of the document below the document scroll point can be redrawn as a buffer. In general, in the scroll mode, the portion of the document redrawn ends at the document scroll point plus a buffer length, where the buffer length is greater than or equal to zero. The process then returns to block 1202 (FIG. 12A).

If the spacer index mode 1260 is selected, then the process passes to block 1262, in which the portion of the document up to and including a document spacer index is redrawn. Spacer indexes were previously described in reference to FIG. 7A and FIG. 7B. An additional portion of the document below the document spacer index can be redrawn as a buffer. In general, in the spacer index mode, the portion of the document redrawn ends at the document spacer index plus a buffer length, where the buffer length is greater than or equal to zero. The process then returns to block 1202 (FIG. 12A).

If the time mode 1270 is selected, then the process passes to block 1272, in which a buffer is filled. The process then passes to block 1274, in which a timer 1 is started. The process then passes to block 1276, in which redrawing of the contents of the buffer is started. The process then passes to block 1280, in which the elapsed time is determined and compared to a predetermined maximum time T1MAX. If the elapsed time is less than T1MAX, then the process passes to block 1278, in which the state of the buffer is determined. If the buffer is not empty, then the process returns to block 1276. If the buffer is empty, then the process returns to block 1202 (FIG. 12A).

Now refer back to block 1280. If the elapsed time is greater than or equal to T1MAX, then the process passes to block 1282, in which the state of the buffer is determined. If the buffer is empty, then the process returns to block 1202 (FIG. 12A). If the buffer is not empty, then the process passes to block 1290 (FIG. 12C), in which a timer 2 is started. The process then passes to block 1292, in which receipt of an edit command is determined. If an edit command is not received, then the process passes to block 1294, in which the elapsed time is determined and compared to a predetermined maximum time T2MAX. If the elapsed time is less than T2MAX, then the process returns to block 1292. If the elapsed time is greater than or equal to T2MAX, then the process returns to block 1274 (FIG. 12B), and a new timer 1 is started.

Now refer back to block 1292. If an edit command has been received, then the process returns to block 1220 (FIG. 12B).

Systems, apparatus, and methods described herein can be implemented with digital circuitry or with one or more computers. A computer includes well-known processors, memory units, storage devices, software, and other components. Typically, a computer includes one or more processors for executing computer program instructions and one or more memory units for storing data, including computer programming instructions. A computer can also include, or be operatively coupled to, one or more mass storage devices. A mass storage device can be a fixed internal device or a removable external device. Examples of mass storage devices include magnetic hard drives, optical disks, magneto-optical disks, and non-volatile semiconductor memory.

Systems, apparatus, and methods described herein can be implemented with computers operating in a client-server relationship. Typically, the client computers are located remotely from the server computer. The client computers communicate with the server computer via a communications network. The client-server relationship can be defined by, and controlled by, computer programs running on the respective client and server computers.

Systems, apparatus, and methods described herein can be used within a network-based cloud-computing system. In a network-based cloud-computing system, a computer server communicates with one or more client computers via a communications network. A client computer can communicate with the server computer, for example, via a network browser application residing on and operating on the client computer. A client computer can store and access data on the server computer via the communications network. A client computer can transmit requests for data and requests for online services to the server computer via the communications network. The server computer can perform the requested services and provide data to the client computer via the communications network. The server computer can also transmit computer program instructions and data adapted to cause a client computer to perform a specified function, such as performing a calculation or displaying specified data on a video display.

Systems, apparatus, and methods described herein can be implemented using a computer program tangibly embodied in an information carrier, such as a non-transitory machine-readable storage device, for execution by a programmable processor. The method steps described herein can be implemented using one or more computer programs that are executable by a programmable processor. A computer program is a set of computer program instructions that can be used, directly or indirectly, in a computer to perform a specified activity or bring about a specified result. A computer program can be written in any form of programming language, including compiled or interpreted languages, and it can be deployed in any form, including a stand-alone program or a module, component, subroutine, or other unit suitable for use in a computing environment.

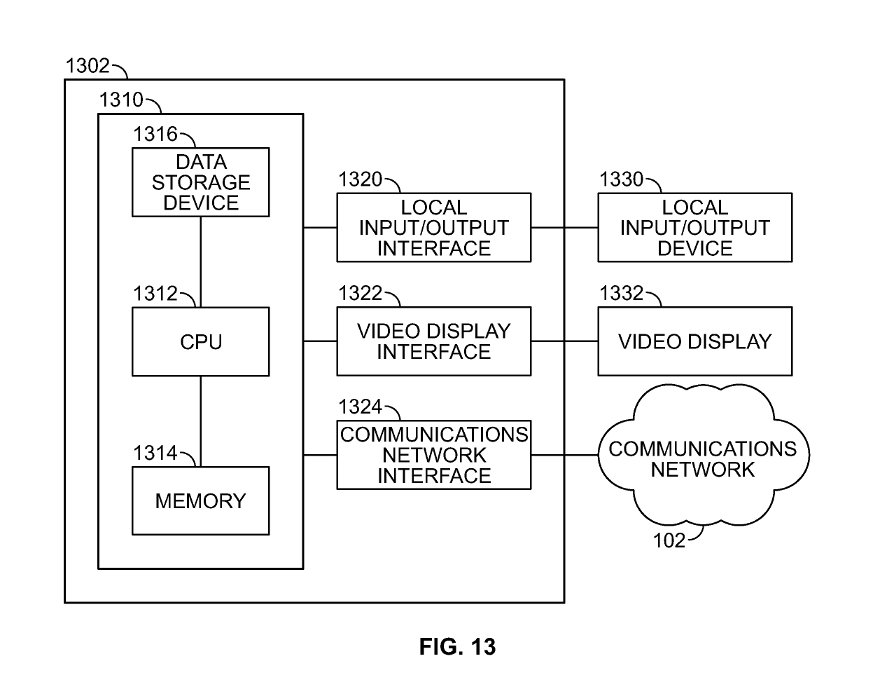

FIG. 13 shows an example of a computational system for implementing an online document processor. Computational system 1302, for example, can be an embodiment of applications server 1 110 in FIG. 1. The methods shown in the flowcharts of FIG. 11A-FIG. 11D and FIG. 12A-FIG. 12C can be performed by computational system 1302. One skilled in the art can construct the computational system 1302 from various combinations of hardware and software (including firmware). One skilled in the art can construct the computational system 1302 from various combinations of electronic components, such as general purpose microprocessors, digital signal processors (DSPs), application-specific integrated circuits (ASICs), field-programmable gate arrays (FPGAs), random access memory, and non-volatile read-only memory.

Computational system 1302 includes computer 1310, which includes a central processing unit (CPU) 1312, memory 1314, and data storage device 1316. Data storage device 1316 includes at least one non-transitory, persistent, tangible computer readable medium, such as a hard drive, compact disc, or non-volatile semiconductor memory.

Computational system 1302 can further include local input/output interface 1320, which interfaces computer 1310 with local input/output device 1330, such as a keyboard, mouse, or local access terminal. Data, including computer executable code, can be transferred to and from computer 1310 via local input/output interface 1320. Computational system 1302 can further include video display interface 1322, which drives video display 1332. Computational system 1302 can also receive input via video interface 1322 (for example, if video display 1332 includes a touch screen). Note that, in this instance, local input/output device 1330 and video display 1332 are operated by an applications service provider and not by an end user (examples of end users include user 1 120-user 3 124 in FIG. 1).

Computational system 1302 can further include communications network interface 1324, which interfaces computer 1310 with communications networks, such as local area networks and wide area networks. An example of a communications network is communications network 102 in FIG. 1. Data, including computer executable code, can be transferred to and from computer 1310 via communications network interface 1324. Computational system 1302 can be remotely accessed and controlled via communications network 102. User input can be received and user output can be sent via communications network interface 1324.

As is well known, a computer operates under control of computer software, which defines the overall operation of the computer and applications. CPU 1312 controls the overall operation of the computer and applications by executing computer program instructions that define the overall operation and applications. The computer program instructions can be stored in data storage device 1316 and loaded into memory 1314 when execution of the program instructions is desired. The methods shown in the flowcharts in FIG. 11A-FIG. 11D and FIG. 12A-FIG. 12C can be defined by computer program instructions stored in memory 1314 or in data storage device 1316 (or in a combination of memory 1314 and data storage device 1316) and controlled by the CPU 1312 executing the computer program instructions. For example, the computer program instructions can be implemented as computer executable code programmed by one skilled in the art to perform algorithms implementing the methods shown in the flowcharts in FIG. 11A-FIG. 11D and FIG. 12A-FIG. 12C. Accordingly, by executing the computer program instructions, the CPU 1312 executes algorithms implementing the methods shown in the flowcharts in FIG. 11A-FIG. 11D and FIG. 12A-FIG. 12C.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for redrawing with an online document processor a document stored on an applications server, the method comprising:
receiving a download command;
downloading by the applications server a first portion of the document;
redrawing the first portion of the document;
downloading by the applications server a second portion of the document;
in response to receiving an edit command within a predetermined time interval starting from completion of the downloading of the second portion of the document, executing the received edit command; and
in response to not receiving an edit command within the predetermined time interval, redrawing at least a part of the second portion of the document.

2. The method of claim 1, wherein the first portion of the document ends at a location determined by a sum of a document end-of-display point and a buffer length, wherein the buffer length is greater than or equal to zero.

3. The method of claim 1, wherein the predetermined time interval is a first predetermined time interval, and wherein redrawing at least a part of the second portion of the document comprises:
redrawing at least a part of the second portion of the document for a maximum of a second predetermined time interval.

4. The method of claim 3, wherein the received edit command is a first edit command, further comprising:
upon completion of redrawing at least a part of the second portion of the document, waiting for receipt of a second edit command for a maximum of a third predetermined time interval.

5. The method of claim 1, wherein executing the received edit command comprises:
redrawing the first portion of the document and the second portion of the document.

6. The method of claim 1, wherein executing the received edit command comprises:
downloading by the applications server a third portion of the document, the third portion comprising the remaining portion of the document not previously downloaded; and
redrawing the entire document.

7. The method of claim 1, wherein executing the received edit command comprises:
redrawing a third portion of the document, the third portion ending at a location determined by a sum of a document end-of-display point and a buffer length, wherein the buffer length is greater than or equal to zero.

8. The method of claim 1, wherein executing the received edit command comprises:
redrawing a third portion of the document, the third portion ending at a location determined by a sum of a document scroll point and a buffer length, wherein the buffer length is greater than or equal to zero.

9. The method of claim 1, wherein executing the received edit command comprises:
redrawing a third portion of the document, the third portion ending at a location determined by a sum of a document spacer index and a buffer length, wherein the buffer length is greater than or equal to zero.

10. The method of claim 1, wherein the predetermined time interval is a first predetermined time interval, and wherein executing the received edit command comprises:
redrawing at least a part of the second portion of the document for a maximum of a second predetermined time interval.

11. The method of claim 10, wherein the received edit command is a first edit command, further comprising:
upon completion of redrawing at least a part of the second portion of the document, waiting for receipt of a second edit command for a maximum of a third predetermined time interval.

12. A computer readable medium storing computer program instructions for redrawing with an online document processor a document stored on an applications server, the computer program instructions defining the steps of:
receiving a download command;
downloading by the applications server a first portion of the document;
redrawing the first portion of the document;
downloading by the applications server a second portion of the document;
in response to receiving an edit command within a predetermined time interval starting from completion of the downloading of the second portion of the document, executing the received command; and
in response to not receiving an edit command within the predetermined time interval, redrawing at least a part of the second portion of the document.

13. The computer readable medium of claim 12, wherein the first portion of the document ends at a location determined by a sum of a document end-of-display point and a buffer length, wherein the buffer length is greater than or equal to zero.

14. The computer readable medium of claim 12, wherein the predetermined time interval is a first predetermined time interval, and wherein the computer program instructions defining the step of, in response to not receiving an edit command within the predetermined time interval, redrawing at least a part of the second portion of the document comprise computer program instructions defining the step of:
in response to not receiving an edit command within a first predetermined time interval, redrawing at least a part of the second portion of the document for a maximum of a second predetermined time interval.

15. The computer readable medium of claim 14, wherein the received edit command is a first edit command, and wherein the computer program instructions defining the step of, in response to not receiving an edit command within the predetermined time interval, redrawing at least a part of the second portion of the document further comprise computer program instructions defining the step of:
upon completion of redrawing at least a part of the second portion of the document, waiting for receipt of a second edit command for a maximum of a third predetermined time interval.

16. The computer readable medium of claim 12, wherein the computer program instructions defining the step of, in response to receiving an edit command within a predetermined time interval starting from completion of the downloading of the second portion of the document, executing the received edit command comprise computer program instructions defining the step of:
in response to receiving an edit command within a predetermined time interval starting from completion of the downloading of the second portion of the document, redrawing the first portion of the document and the second portion of the document.

17. The computer readable medium of claim 12, wherein the computer program instructions defining the step of, in response to receiving an edit command within a predetermined time interval starting from completion of the downloading of the second portion of the document, executing the received edit command comprise computer program instructions defining the steps of:
in response to receiving an edit command within a predetermined time interval starting from completion of the downloading of the second portion of the document:
downloading by the applications server a third portion of the document, the third portion comprising the remaining portion of the document not previously downloaded; and
redrawing the entire document.

18. The computer readable medium of claim 12, wherein the computer program instructions defining the step of, in response to receiving an edit command within a predetermined time interval starting from completion of the downloading of the second portion of the document, executing the received edit command comprise computer program instructions defining the step of:
in response to receiving an edit command within a predetermined time interval starting from completion of the downloading of the second portion of the document, redrawing a third portion of the document, the third portion ending at a location determined by a sum of a document end-of-display point and a buffer length, wherein the buffer length is greater than or equal to zero.

19. The computer readable medium of claim 12, wherein the computer program instructions defining the step of, in response to receiving an edit command within a predetermined time interval starting from completion of the downloading of the second portion of the document, executing the received edit command comprise computer program instructions defining the step of:
in response to receiving an edit command within a predetermined time interval starting from completion of the downloading of the second portion of the document, redrawing a third portion of the document, the third portion ending at a location determined by a sum of a document scroll point and a buffer length, wherein the buffer length is greater than or equal to zero.

20. The computer readable medium of claim 12, wherein the computer program instructions defining the step of, in response to receiving an edit command within a predetermined time interval starting from completion of the downloading of the second portion of the document, executing the received edit command comprise computer program instructions defining the step of:
in response to receiving an edit command within a predetermined time interval starting from completion of the downloading of the second portion of the document, redrawing a third portion of the document, the third portion ending at a location determined by a sum of a spacer index and a buffer length, wherein the buffer length is greater than or equal to zero.

21. The computer readable medium of claim 12, wherein the predetermined time interval is a first predetermined time interval, and wherein the computer program instructions defining the step of, in response to receiving an edit command within a predetermined time interval starting from completion of the downloading of the second portion of the document, executing the received edit command comprise computer program instructions defining the step of:
in response to receiving an edit command within a first predetermined time interval starting from completion of the downloading of the second portion of the document, redrawing at least a part of the second portion of the document for a maximum of a second predetermined time interval.

22. The computer readable medium of claim 21, wherein the received edit command is a first edit command, and wherein the computer program instructions defining the step of, in response to receiving an edit command within a predetermined time interval starting from completion of the downloading of the second portion of the document, executing the received edit command further comprise computer program instructions defining the step of:
upon completion of redrawing at a least a part of the second portion of the document, waiting for receipt of a second edit command for a maximum of a third predetermined time interval.

23. An applications server comprising:
a data storage device storing computer program instructions defining the steps of:
receiving a download command;
downloading by the applications server a first portion of a document stored on the applications server;
redrawing the first portion of the document;
downloading by the applications server a second portion of the document;
in response to receiving an edit command within a predetermined time interval starting from completion of the downloading of the second portion of the document, executing the received command; and
in response to not receiving an edit command within the predetermined time interval, redrawing at least a part of the second portion of the document; and
a central processing unit configured to execute the computer program instructions; and
a communications network interface configured to transfer data between the applications server and a communications network.

24. A method for redrawing a document with an online document processor, the method comprising:
receiving an edit command; and
redrawing a portion of the document for a maximum of a predetermined time interval.

25. The method of claim 24, wherein the received edit command is a first edit command, and wherein the predetermined time interval is a first predetermined time interval, further comprising:
upon completion of redrawing the portion of the document for a maximum of a first predetermined time interval, waiting for receipt of a second edit command for a maximum of a second predetermined time interval.

26. A method for redrawing a document with an online document processor, the method comprising:
receiving an edit command; and
based on the received edit command, redrawing a portion of the document, the portion ending at a location determined by one of:
a first sum of a document end-of-display point and a first buffer length, wherein the first buffer length is greater than or equal to zero;
a second sum of a document scroll point and a second buffer length, wherein the second buffer length is greater than or equal to zero; or
a third sum of a document spacer index and a third buffer length, wherein the third buffer length is greater than or equal to zero.

27. The method of claim 26, wherein the received edit command is a first edit command, further comprising:
upon completion of redrawing the portion of the document, waiting for receipt of a second edit command for a maximum of a predetermined time interval.

28. A computer readable medium storing computer program instructions for redrawing a document with an online document processor, the computer program instructions defining the steps of:
receiving an edit command; and
redrawing a portion of the document for a maximum of a predetermined time interval.

29. The computer readable medium of claim 28, wherein the received edit command is a first edit command, wherein the predetermined time interval is a first predetermined time interval, and wherein the computer instructions for redrawing a document with an online document processor further comprise computer program instructions defining the step of:
upon completion of redrawing the portion of the document for a maximum of a first predetermined time interval, waiting for receipt of a second edit command for a maximum of a second predetermined time interval.

30. A computer readable medium storing computer program instructions for redrawing a document with an online document processor, the computer program instructions defining the steps of:
receiving an edit command; and
based on the received edit command, redrawing a portion of the document, the portion ending at a location determined by one of:
a first sum of a document end-of-display point and a first buffer length, wherein the first buffer length is greater than or equal to zero;
a second sum of a document scroll point and a second buffer length, wherein the second buffer length is greater than or equal to zero; or
a third sum of a document spacer index and a third buffer length, wherein the third buffer length is greater than or equal to zero.

31. The computer readable medium of claim 30, wherein the received edit command is a first edit command, and wherein the computer program instructions for redrawing a document with an online document processor further comprise computer program instructions defining the step of:
upon completion of redrawing the portion of the document, waiting for receipt of a second edit command for a maximum of a predetermined time interval.

32. An applications server comprising:
a data storage device storing computer program instructions defining the steps of:
receiving an edit command; and
redrawing a portion of a document for a maximum of a predetermined time interval;
a central processing unit configured to execute the computer program instructions; and
a communications network interface configured to transfer data between the applications server and a communications network.

33. An applications server comprising:
a data storage device storing computer program instructions defining the steps of:
receiving an edit command; and
based on the received edit command, redrawing a portion of the document, the portion ending at a location determined by one of:
a first sum of a document end-of-display point and a first buffer length, wherein the first buffer length is greater than or equal to zero;
a second sum of a document scroll point and a second buffer length, wherein the second buffer length is greater than or equal to zero; or
a third sum of a document spacer index and a third buffer length, wherein the third buffer length is greater than or equal to zero; and
a central processing unit configured to execute computer program instructions; and
a communications network interface configured to transfer data between the applications server and a communications network.
